(19) United States
(12) Patent Application Publication
(10) Pub. No.: US 2001/0020249 A1
(43) Pub. Date: Sep. 6, 2001

(54) System for automatically providing internet services

(75) Inventor: Jae-Bum Shim, Seoul (KR)

Correspondence Address: BAKER & BOTTS, 30 ROCKEFELLER PLAZA, NEW YORK, NY, 10112

(73) Assignee: Logicplant Co., Ltd.

(21) Appl. No.: 09/797,283

(22) Filed: Mar. 1, 2001

(30) Foreign Application Priority Data
Mar. 3, 2000 (KR) 2000-10765

(51) Int. Cl. G06F 15/177; G06F 15/173

(52) U.S. Cl. 709/220; 709/223; 709/224

(57) ABSTRACT

Disclosed is a system for automatically providing Internet services by connection to servers in an Internet network through an Internet connection unit, the system comprising an agent menu module for receiving user commands, analyzing the commands, and performing operations according to the commands; an agent scheduler for intelligently performing automatic operations according to predetermined conditions in order to use the Internet services; an Internet service manager operating according to signals of the agent menu module or the agent scheduler to manage operations for automatically using the Internet services; a service automation module for automatically connecting to Internet sites according to signals of the Internet service manager to enable the use of Internet services desired by the user; an API for enabling the service automation module to use an agent environment; an agent update module for updating the service automation module to a most recent service automation module through communications with a module management server, and for updating set-up information of the service automation module, the agent menu module, and the agent scheduler through communications with the module management server; and an agent action module for displaying messages corresponding to Internet service results obtained by operation of the service automation module.

### BACKGROUND OF THE INVENTION

(a) Field of the Invention

The present invention relates to a system for automatically providing Internet services, and more particularly, to a system in which various Internet services are automatically provided without having to log on to individual Internet service websites.

(b) Description of the Related Art

There is an ever-increasing number of Internet users worldwide. This has been followed by an increase in the ways in which the Internet is used and the number of websites that provide the various services. Internet websites no longer merely provide information to users but also enable users to process and convert information.

However, in order to use the services offered by websites, users must have knowledge of the individual websites. Also, in order to obtain needed information, a connection must be made to the individual websites providing information. In particular, if the exact address of the Internet site providing the required information and services is not known, it is necessary to undergo the often cumbersome process of searching for the website that has the information or services that are needed.

### SUMMARY OF THE INVENTION

The present invention has been made in an effort to solve the above problems.

It is an object of the present invention to provide a system in which Internet services can be used without having to log on to individual Internet service websites.

To achieve the above object, the present invention provides a system for automatically providing Internet services by connection to servers in an Internet network through an Internet connection unit, the system comprising an agent menu module for receiving user commands, analyzing the commands, and performing operations according to the commands; an agent scheduler for intelligently performing automatic operations according to predetermined conditions in order to use the Internet services; an Internet service manager operating according to signals of the agent menu module or the agent scheduler to manage operations for automatically using the Internet services; a service automation module for automatically connecting to Internet sites according to signals of the Internet service manager to enable the use of Internet services desired by the user; an API for enabling the service automation module to use an agent environment; an agent update module for updating the service automation module to a most recent service automation module through communications with a module management server, and for updating set-up information of the service automation module, the agent menu module, and the agent scheduler through communications with the module management server; and an agent action module for displaying messages corresponding to Internet service results obtained by operation of the service automation module.

According to a feature of the present invention, the Internet service manager comprises a scripting host, which is driven to use Internet services according to the signals of the agent menu module or agent scheduler.

According to another feature of the present invention, the service automation module comprises a script module and an operation module, the script module being operated by the scripting host to enable the automatic reception of Internet services without user connection to Internet sites, and the operation module being operated by the Internet service manager for enabling the automatic reception of Internet serves without user connection to Internet sites.

According to yet another feature of the present invention, the agent update module comprises a log-in unit for connecting to the module management server; a module update unit for updating the service automation module to a most recent service automation module through communications with the module management server; and a set-up update unit for updating setup information of the service automation module, the agent menu module, and the agent scheduler with most recent set-up information through communications with the module management server.

According to still yet another feature of the present invention, the module management server comprises an account server for managing user authorizations; a log-in server for managing user log-in information; an update server for managing the updating of information of the service automation module, and of set-up information of the service automation module, the agent menu module, and the agent scheduler; and a DBMS for storing the service automation module, user information, and agent update information.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of a system for automatically providing Internet services according to a preferred embodiment of the present invention;

FIG. 2 is a flow chart of overall operations of the system of FIG. 1

FIG. 3 is a flow chart of operations performed by an agent scheduler of the system of FIG. 1;

FIG. 4 is a flow chart of operations to update a service automation module of the system of FIG. 1;

FIG. 5 is a flow chart of update operations a user set-up of the system of FIG. 1;

FIG. 6 is a flow chart of operations performed by a service automation module of the system of FIG. 1;

FIG. 7 is a flow chart of operations for updating a service automation module of a terminal of the system of FIG. 1; and

FIG. 8 is a flow chart of set-up updating operations of a terminal of the system of FIG. 1.

### DETAILED DESCRIPTION OF THE PREFERRED EMBODIMENTS

Preferred embodiments of the present invention will now be described in detail with reference to the accompanying drawings.

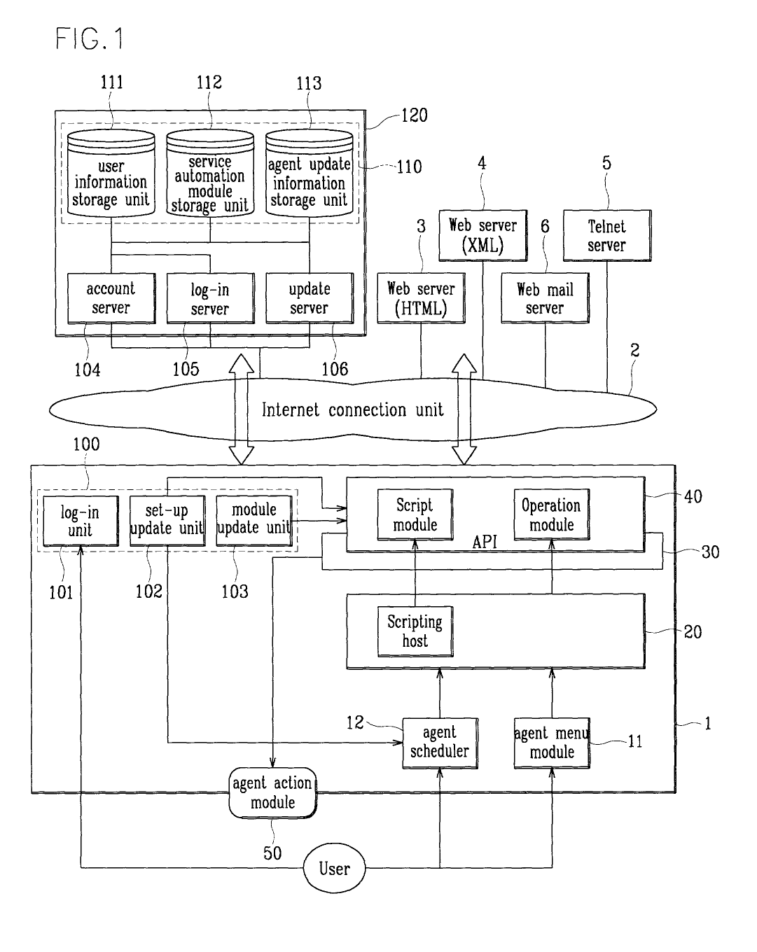

FIG. 1 shows a schematic view of a system for automatically providing Internet services according to a preferred embodiment of the present invention.

As shown in the drawing, the system for automatically providing Internet services includes an Internet connection unit 2, an agent menu module 5, 11, an agent scheduler 12, an Internet service manager 20, an API (application program interface) 30, a service automation module 40, an agent action module 50, a module management server 120, and an agent update module 100.

The Internet connection unit 2 controls the physical connection between the Internet and a terminal 1, which includes a computer, CellVic, mobile phone, and other devices capable of Internet communications. The agent menu module 11 receives and analyzes user commands received from the terminal 1, and performs operations corresponding to the analyzed commands.

The agent scheduler 12 intelligently performs automatic operations for using Internet services according to established conditions. The Internet service manager 20 includes a scripting host, and operates according to signals of the agent menu module 11 and agent scheduler 12 to manage operations of the terminal for the automatic use of Internet services. The API 30 enables the use of specific functions or the use of an agent environment by service modules.

The service automation module 40 includes a script module for automatically providing Internet services in a script format or an operation module for automatically providing Internet serves according to a program. The script module or operation module enables the automatic reception of Internet services from the terminal 1 even without connection to one of a plurality of servers 3, 4, 5 and 6 which provide Internet services.

The agent action module 50 transmits to the user of the terminal 1 messages of Internet service results obtained by the operation of the service automation module 40.

The module management server 120 includes an account server 104 for managing user authorization and composition; a log-in server 105 for managing user log information, an update server 106 for managing maintenance repairs of the service automation module 40; and a DBMS (database management system) 110 for managing the storage of the service automation module 40, user information, and agent update information. The DBMS 110 includes a user information storage unit 111 for storing user information; a service automation module storage unit 112 for storing the service automation module 40; and an agent update information storage unit 113 for storing the user information, service automation module, and agent update information. The DBMS 110 provides, via the network, user authorization accounts, and information on the service automation module 40 and set-up of the terminal 1.

The agent update module 100 includes a log-in unit 101 for connection to the module management server 120, a set-up update unit 102 for updating a set-up of the service automation module 40, and a module update unit 103 for updating the service automation module 40. The agent update module 100 updates to the most recent information the service automation module 40 and set-up of the terminal 1. The agent update module 100 performs this function through communications with the module management server 120.

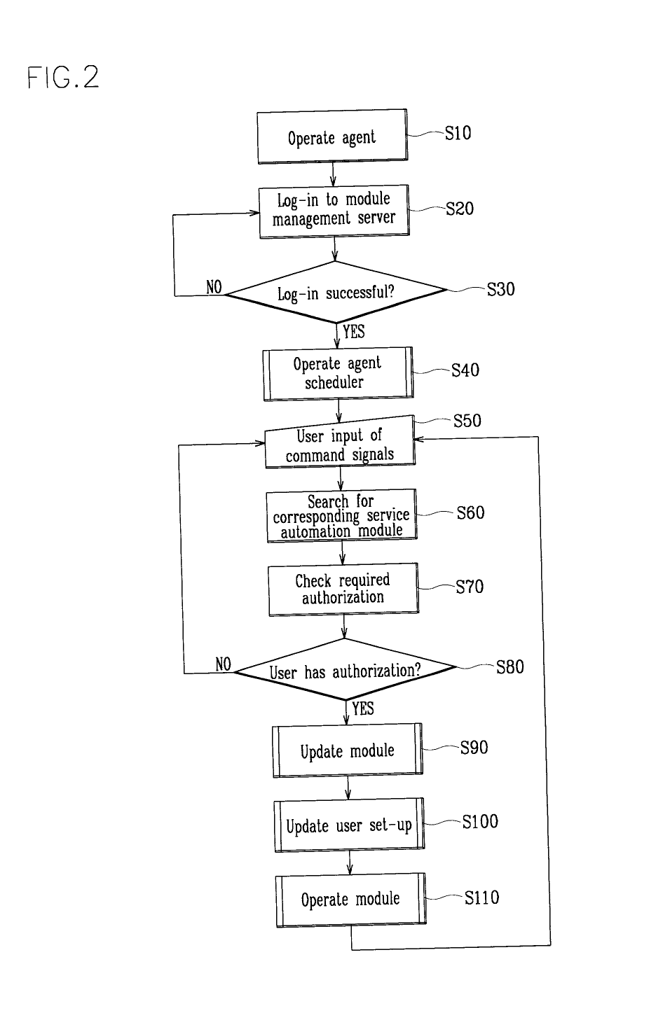

FIG. 2 shows a flow chart of overall operations of the system of the present invention described above.

First, in a state where the terminal 1 is connected to the Internet through operations of the Internet connection unit 2, the user operates the agent for operating the system of the present invention in step S10. The log-in unit of the agent update module 100 then logs in to the module management server 120 in step S20. As a result, the account server 104 and log-in server 105 of the module management server 120 compare user information transmitted from the log-in unit 101 with user information stored in the user information storage unit 111 to verify if the user has permission to access the system.

Next, it is determined if log-in to the module management server 120 has been successful in step S30. Step S20 is repeated if log-in is not successful. However, if log-in is successful, the agent scheduler 12 is operated such that automatic operation according to established conditions are performed in step S40.

Subsequently, the user inputs specific command signals through the agent menu module 11 in order to use Internet services in step S50. Accordingly, the agent menu module 11 analyzes the command signals then searches for a service automation module corresponding to the command in step S60 (the service automation module 40 for purposes of explanation). Next, the required authorization to use the searched service automation module 40 is checked in step S70, then it is determined if the user has the authorization in step S80. That is, it is determined if the user of the terminal 1 is registered to use the service automation module 40.

In step S80, if the user does not have authorization to use the searched service automation module 40, the operation of the service automation module 40 is discontinued and the process is returned to step S50. However, if the user is found to have authorization to use the searched automation module 40, the agent update module 100, through communications with the module management server 120, updates the searched service automation module 40 to a most recent service automation module in step S90.

The agent update module 100, through communications with the module management server 120, then updates to most recent information a user set-up in the agent menu module 11, agent scheduler 12, and service automation module 40 in step S100. That is, set-up information established by the user when previously logged on for using an Internet service through the service automation module 40 and set-up information with regard to various operations to operate the Internet service are updated such that the user can use the terminal 1 with the same set-up parameters regardless of where the Internet services are used.

Next, according to signals of the agent menu module 11, the Internet service manager 20 operates the searched service automation module 40 through the API 30 such that a connection is made with the servers 3, 4, 5 and 6, thereby enabling the automatic use of Internet services even without connection to the Internet service servers by the user in step S110.

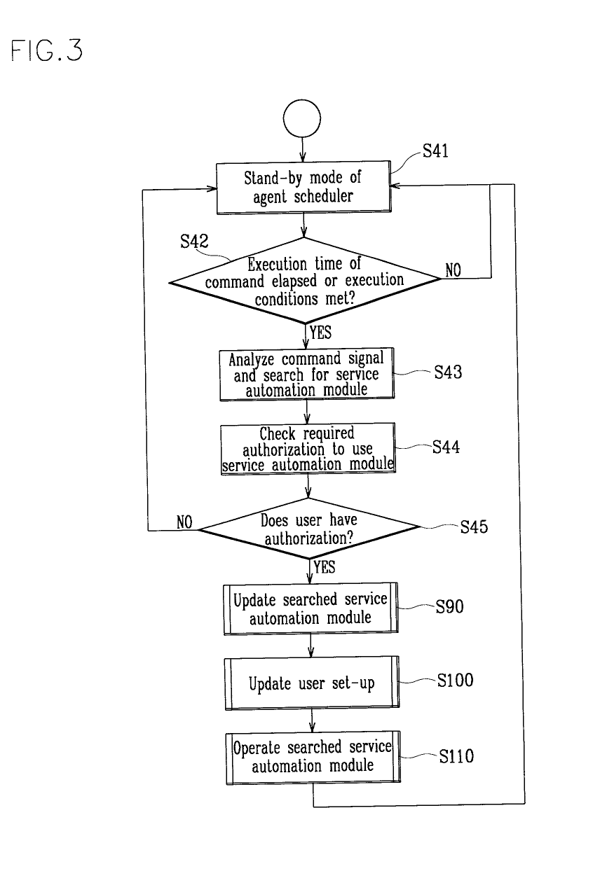

FIG. 3 shows a flow chart of operations performed by the agent scheduler 12.

First, with the operation of the agent scheduler 12 in step S40 of FIG. 2, the agent scheduler 12 goes into a stand-by mode in step S41 of FIG. 3. In this state, it is determined if an execution time of an established command has elapsed or execution conditions of the established command have been met in step S42. If not, step S41 is repeated. However, if the execution time has elapsed or the execution condition has been satisfied, the agent scheduler 12 analyzes a command signal then searches for a service automation module matching the command in step S43 (the service automation module 40 for purposes of explanation).

Next, the required authorization to use the searched service automation module 40 is checked in step S44, then it is determined if the user has the authorization in step S45. That is, it is determined if the user of the terminal 1 is registered to use the service automation module 40. If the user does not have authorization, the operation of the service automation module 40 is discontinued and the process is returned to step S41. However, if the user is found to have authorization to use the searched automation module 40, the agent update module 100, through communications with the module management server 120, updates the searched service automation module 40 to a most recent service automation module in step S90.

The agent update module 100, through communications with the module management server 120, then updates to most recent information a user set-up in the agent menu module 11, agent scheduler 12, and service automation module 40 in step S100. That is, set-up information established by the user when previously logged on for using an Internet service through the service automation module 40 and set-up information with regard to various operations to operate the Internet service are updated such that the user can use the terminal 1 with the same set-up parameters regardless of where the Internet services are used.

Next, according to signals of the agent menu module 11, the Internet service manager 20 operates the searched service automation module 40 through the API 30 such that a connection is made with the servers 3, 4, 5 and 6, thereby enabling the automatic use of Internet services even without connection to the Internet service servers by the user in step S10.

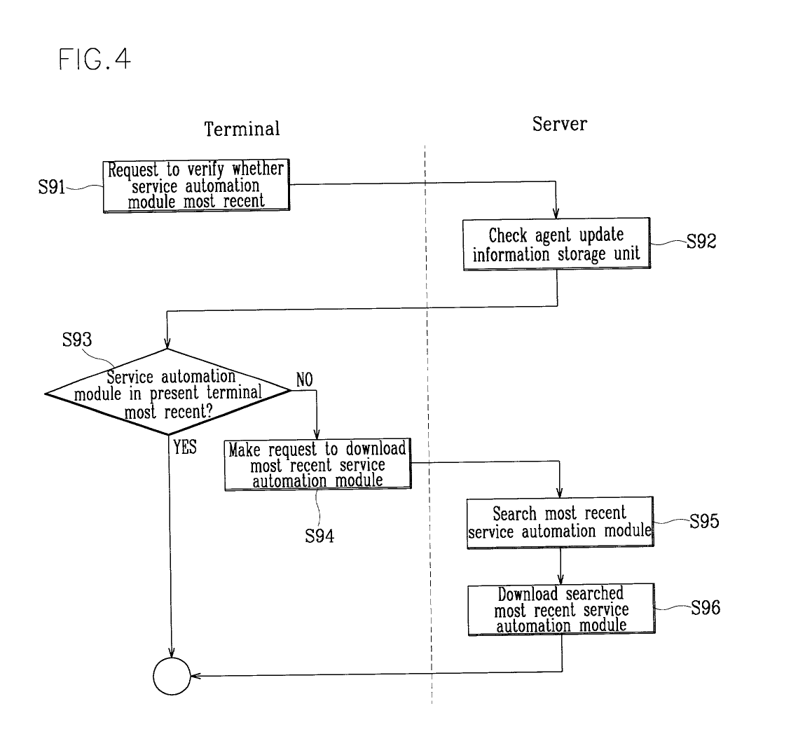

FIG. 4 shows a flow chart of operations to update the service automation module 40 to the most recent service automation module.

In a state where the user is logged on to the module management server 120 through the terminal 1, if the agent menu module 11 or the agent scheduler 12 operates the module update unit 103 of the agent update module 100 in order to update the service automation module 40, the module update unit 103 makes a request to the update server 106 of the module management server 120 to verify whether the service automation module 40 installed in the present terminal is a most recent service automation module in step S91. As a result, the update server 106 checks the agent update information storage unit 113 of the DBMS 110 in step S92 then transmits agent update information corresponding to the module update to the module update unit 103 of the terminal 1.

Next, according to the agent update information transmitted from the update server 106, the module update unit 103 determines if the service automation module 40 installed in the present terminal 1 is a most recent service automation module in step S93. If the service automation module 40 installed in the present terminal is a most recent service automation module, the module update operation is discontinued.

However, if the service automation module 40 installed in the present terminal is not a most recent service automation module, a request to download a most recent service automation module to the update server 106 is made in step S94. Accordingly, the update server 106 searches a most recent service automation module in the service automation module storage unit 112 of the DBMS 110 in step S95 then downloads the searched most recent service automation module to the module update unit 103 in step S96. The module update unit 103 then updates the service automation module 40 installed in the terminal 1 to the downloaded most recent service automation module. As a result, the most recent Internet service is always automatically used even if the user alters the way in which information of an Internet site is displayed. The module update unit 103 also stores update information of the service automation module of the terminal 1 in the agent update information storage unit 113 through the update server 106.

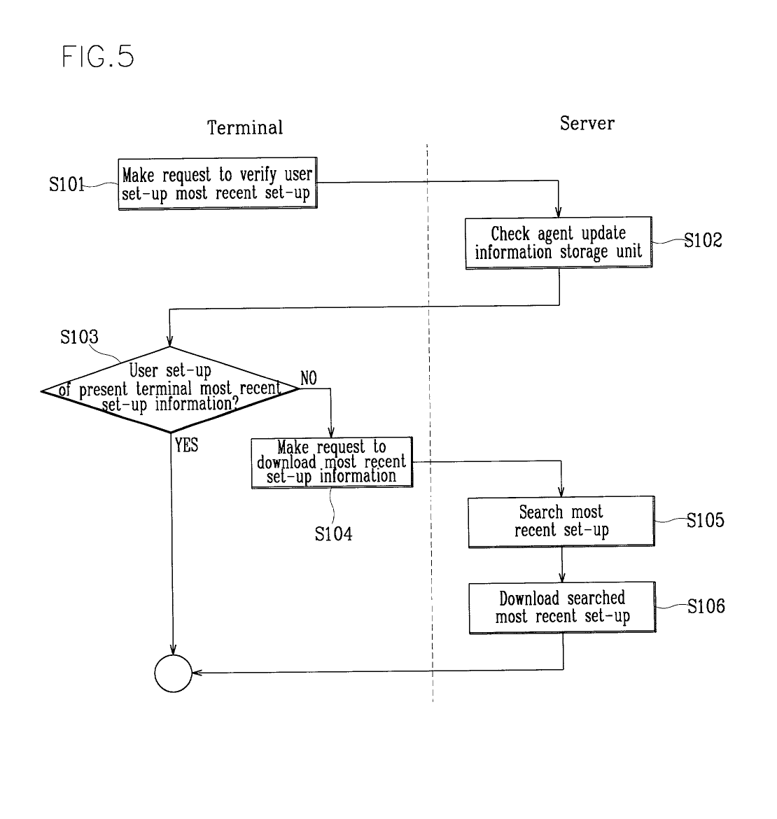

FIG. 5 shows a flow chart of update operations of a user set-up in the agent menu module 11, agent scheduler 12, and service automation module 40.

In a state where the user is logged on to the module management server 120 through the terminal 1, if the agent menu module 11 or the agent scheduler 12 operates the set-up update unit 102 of the agent update module 100 in order to update the agent menu module 11, agent scheduler 12, and service automation module 40, the set-up update unit 102 makes a request to the update server 106 of the module management server 120 to verify whether the user set-up of the present terminal 1 is most recent set-up information in step S101. As a result, the update server 106 checks the agent update information storage unit 113 of the DBMS 110 in step S102 then transmits agent update information corresponding to the user set-up update to the set-up update unit 102 of the terminal 1.

Next, according to the agent update information transmitted from the update server 106, the set-up update unit 102 determines if the user set-up of the present terminal 1 is most recent set-up information in step S103. If the user set-up of the present terminal 1 is the most recent set-up information, the set-up update operation is discontinued. That is, if the user set-up of the present terminal 1 is identical to set-up information for using the service automation module 40 through the Internet and set-up information to run various operations for using Internet services when previously logged on, the set-up update operation is terminated. Accordingly, the user utilizes the Internet services according to the user set-up of the present terminal 1 .

However, if the user set-up of the present terminal 1 is not most recent set-up information, the set-up update unit 102 makes a request to download most recent set-up information to the update server 106 in step S104. Accordingly, the update server 106 searches a most recent set-up in the user information storage unit 111 of the DBMS 110 in step S105 then downloads the searched most recent set-up to the set-up update unit 102 in step S106. The set-up update unit 102 then updates the user set-up of the agent menu module 11, agent scheduler 12, and service automation module 40 to the most recent set-up using the downloaded set-up.

That is, if the user, when previously logged on, establishes a user setup or performs various operations to use an Internet service through the service automation module 40, then again logs on to use the Internet service when previously logged on through a terminal of a different location, the user set-up to use the Internet service or to perform various operations to use the Internet service is updated such that the Internet service is used with the same terminal set-up as when previously logged on. Accordingly, the user can use the Internet service with the same set-up and operative environment regardless of the location of the terminal. Further, the set-up update unit 102, via the update server 106, stores information of the user set-up to use the Internet service and user set-up for performing various operations to use the Internet service at the terminal in the present location in the user information storage unit 111. The stored set-up update information is also stored in the agent update information storage unit 113.

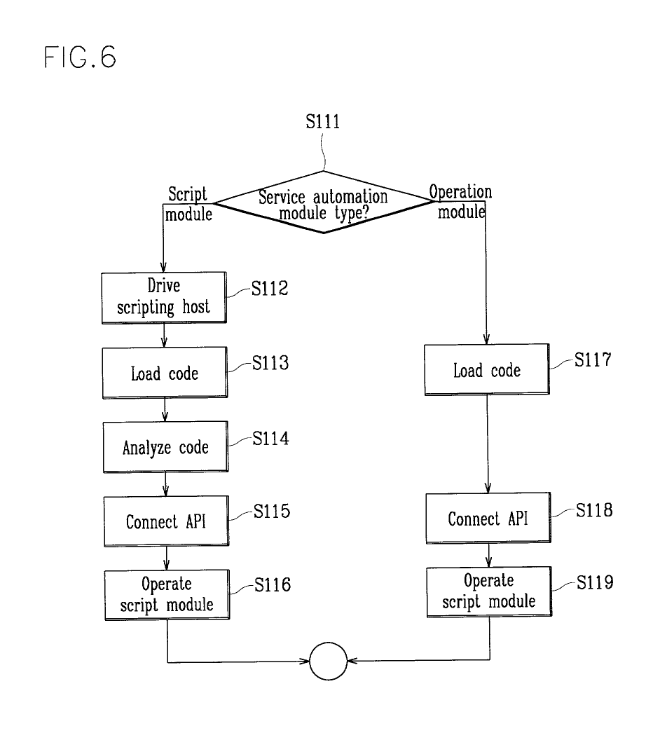

FIG. 6 shows a flow chart of operations performed by the service automation module 40 during the use of the Internet service by the user.

If there is a user command for using an Internet service or a command for an automatic operation, the agent menu module 11 or agent scheduler 12 searches a service automation module corresponding to the user command or automatic operation command then determines the type of the service automation module 40 to be operated in step S1. At this time, if the service automation module 40 to be operated is a script module, the agent menu module 11 or agent scheduler 12 drives the scripting host of the Internet service manager 20 in step S112. Accordingly, the scripting host of the Internet service manager 20 loads a code corresponding to the command transmitted from the agent menu module 11 or the agent scheduler 12 in step S113. The loaded code is then analyzed to check the Internet service to be received by the user or for performing automatic operations in step S114. Next, the scripting host of the Internet service manager 20 connects the API 30 in step S115 then operates the script module of the service automation module 40 in step S116.

In step S111, if it is determined that the service automation module 40 to be operated is an operation module, the agent menu module 11 or the agent scheduler 12 drives the Internet service manager 20. Accordingly, the Internet service manager 20 loads a code corresponding to the command transmitted from the agent menu module 11 or the agent scheduler 12 in step S117. Next, the API 30 is connected in step S118 then the operation module of the service automation module 40 is operated in step S119.

As a result, the service automation module 40 operating by the script module or operation module connects to the servers 3, 4, 5 and 6 to perform the operations as instructed by the user. Also, operation states resulting by the operation of the service automation module 40 and their results are displayed through the agent action module 50 for the user to view.

In the above, the Internet service to be received by the user does not simply check for information. Instead, in the case of requiring results from an Internet site, the agent menu module 11 or the agent scheduler 12 connects to the servers 3, 4, 5 and 6 through the service automation module to perform commands of each Internet site, and in order to perform monitoring of pattern variations of each Internet site in the agent scheduler 12, operations of the service automation module 40 are registered as automatic operations such that results by user commands provided from each Internet site are determined. Accordingly, the agent scheduler 12 operates the service automation module 40 using the same method to monitor the pattern variations of each Internet site, and if the results of user commands are provided from each Internet site so that pattern variations occur, the results are checked and displayed through the agent action module 50 to alert the user.

An example of the use of an Internet service according to the operations of the service automation module 40 will now be described.

In the case of posting a question on a bulletin board of each Internet site and receiving a reply, if the user gives a command to post a question regarding subject “A” on the bulletin board of the Internet sites, the agent menu module 11 drives the Internet service manager 20 to operate the service automation module 40 through the API. As a result, the service automation module 40 connects to the servers 3, 4 and 5 that provide information on subject “A” and a question of subject “A” is automatically posted in the bulletin boards provided in each server 3, 4 and 5. Next, the agent menu module 11 registers the operations of the service automation module 40 as automatic operations in the agent scheduler 12 in order to monitor pattern variations of each bulletin board. Hence, the agent scheduler 12 operates the service is automation module 40 through automatic operations to monitor pattern variations of each bulletin board, and if the reply to the question regarding subject “A” is posted on the bulletin boards and bulletin board pattern variations are detected, the reply to the question is checked then displayed through the agent action module 50 to enable user verification.

Further, in addition to obtaining information through the user of Internet services, various other services such as telephone dialing using the Internet can be automatically used without the user directly connecting to Internet sites.

Additionally, when checking mail received at a plurality of the mail servers 6, if the user sends a mail check command through the agent menu module 11 or if there is a command of the agent scheduler 12 as a result of automatic operations, the Internet service manager 20 operates to initiate operation of the service automation module 40 through the API 30. As a result, the service automation module 40 connects to the various mail servers 6 designated by the user (e.g., POP3, IMAP4, web mail, PC communications mail), integrates the mail received through the user's account, and displays the mail to enable viewing by the user. Therefore, received mail can be automatically viewed without the user having to connect to each mail server 6.

Through the above operations of the present invention, when there is an update request from the user terminal, the most recent service automation module is downloaded from the servers to maintain the most recent Internet site information. Further, even without a request signal from the terminal, information of the terminal is determined in the server such that update operations can be controlled.

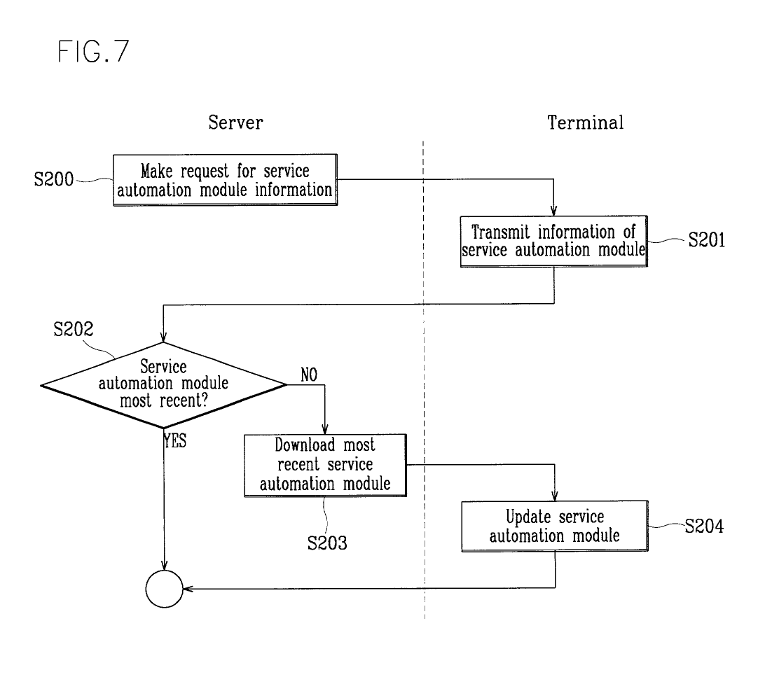

FIG. 7 shows a flow chart of operations for updating the service automation module 40.

If the user logs on to the module management server 120 through the terminal 1, the update server 106 of the module management server 120 makes a request to transmit information regarding the service automation module 40 installed in the present terminal 1 to the module update unit 103 in step S200. Accordingly, information regarding the service automation module 40 installed in the present terminal 1 is transmitted from the module update unit 103 in step S201. The update server 106 then compares the information of the service automation module 40 transmitted from the module update unit 103 with update information stored in the agent update information storage unit 113 to determine if the service automation module 40 installed in the present terminal 1 is a most recent service automation module in step S202.

Subsequently, if the service automation module 40 installed in the present terminal 1 is the most recent service automation module, the update server 106 discontinues the module update operation. However, if the service automation module 40 installed in the present terminal 1 is not the most recent service automation module, the update server 106 searches for the most recent service automation module in the service automation module storage unit 112 then downloads the most recent service automation module to the module update unit 103 of the terminal 1 in step S203. Next, the module update unit 103 updates the service automation module 40 in the present terminal 1 with the most recent service automation module downloaded from the update server 106 in step S204. Also, the update server 106 stores service automation module update information of the terminal 1 in the agent update information storage unit 113.

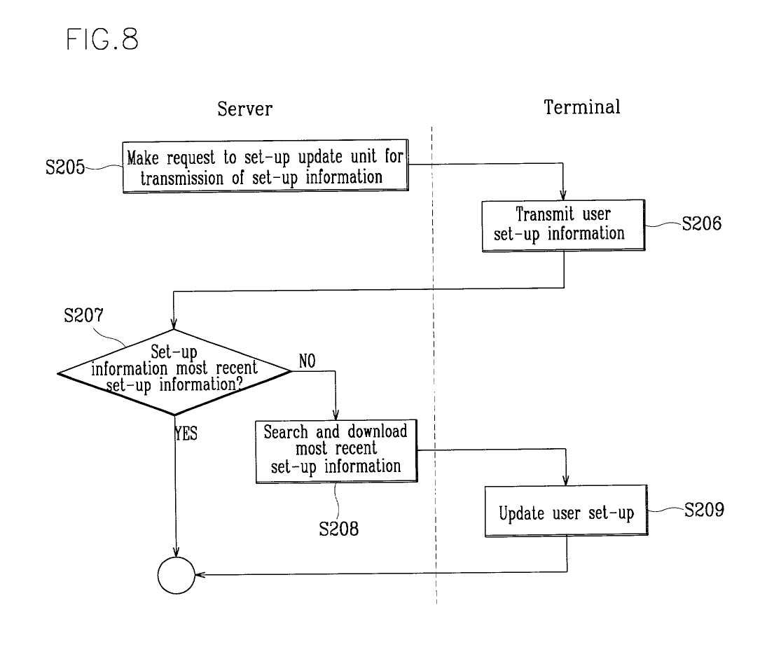

FIG. 8 shows a flow chart of set-up updating operations of the agent menu module 11, agent scheduler 12, and service automation module 40 of the terminal 1.

If the user logs on to the module management server 120 through the terminal 1, the update server 106 of the module management server 120 makes a request to transmit user set-up information of the agent menu module 11, agent scheduler 12, and service automation module 40 of the present terminal 1 to the set-up update unit 102 in step S205. Accordingly, the set-up update unit 102 transmits the user set-up information of the agent menu module 11, agent scheduler 12, and service automation module 40 of the present terminal 1 in step S206. The update server 106 then compares the user set-up information of the agent menu modulel 1, agent scheduler, and service automation module 40 transmitted from the set-up update unit 102 with user set-up update information stored in the agent update information storage unit 113 to determine if the set-up information received from the set-up update unit 102 is most recent set-up information in step S207.

Subsequently, if the set-up information is most recent set-up information, that is, if the set-up of the present terminal 1 is most recent, the update server 106 discontinues the set-up update operation of the terminal 1. However, if the set-up information is not most recent set-up information, the update server 106 searches for the most recent set-up information established when previously logged on to use the Internet through the service automation module 40 and the most recent set-up information established when previously logged on for a variety of operations performed to use Internet services, then downloads the most recent set-up information to the set-up update unit 102 of the terminal 1 in step S208. Next, the set-up update unit 102 updates the user set-up of the agent menu module 11, agent scheduler 1, and service automation module 40 using the downloaded most recent set-up information in step S209. Also, the update server 106 receives from the set-up update unit 2 of the terminal 1 the transmission of the set-up information to use the Internet through the service automation module 40 and the set-up information for a variety of operations performed to use Internet services, and stores the same in the user information storage unit 111. The update server 106 further stores the set-up update information in the agent update information storage unit 113.

In the present invention as described above, user convenience is realized by making it possible to automatically use Internet services without the user having to log on to individual Internet service websites, and services can be used without making repeated input of materials and visiting Internet sites. Further, since information of the terminal is continuously updated by the servers, the most Internet services are always used, and the user set-up can be updated with the same parameters regardless of the location of the terminal where the user logs on.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A system for automatically providing Internet services by connection to servers in an Internet network through an Internet connection unit, the system comprising:
an agent menu module for receiving user commands, analyzing the commands, and performing operations according to the commands;
an agent scheduler for intelligently performing automatic operations according to predetermined conditions in order to use the Internet services;
an Internet service manager operating according to signals of the agent menu module or the agent scheduler to manage operations for automatically using the Internet services;
a service automation module for automatically connecting to Internet sites according to signals of the Internet service manager to enable the use of Internet services desired by the user;
an API for enabling the service automation module to use an agent environment;
an agent update module for updating the service automation module to a most recent service automation module through communications with a module management server, and for updating set-up information of the service automation module, the agent menu module, and the agent scheduler through communications with the module management server; and
an agent action module for displaying messages corresponding to Internet service results obtained by operation of the service automation module.

2. The system of claim 1 wherein the Internet service manager comprises a scripting host which is driven to use Internet services according to the signals of the agent menu module or agent scheduler.

3. The system of claim 2 wherein the service automation module comprises a script module and an operation module, the script module being operated by the scripting host to enable the automatic reception of Internet services without user connection to Internet sites, and the operation module being operated by the Internet service manager for enabling the automatic reception of Internet serves without user connection to Internet sites.

4. The system of claim 3 wherein the agent update module comprises:
a log-in unit for connecting to the module management server;
a module update unit for updating the service automation module to a most recent service automation module through communications with the module management server; and
a set-up update unit for updating set-up information of the service automation module, the agent menu module, and the agent scheduler with most recent set-up information through communications with the module management server.

5. The system as in any one of claims 1-4 wherein the module management server comprises:
an account server for managing user authorizations;
a log-in server for managing user log-in information;
an update server for managing the updating of information of the service automation module, and of set-up information of the service automation module, the agent menu module, and the agent scheduler; and
a DBMS for storing the service automation module, user information, and agent update information.

6. A system for automatically providing Internet services without direct user connection to Internet sites by operation of a service automation module, which automatically connects to Internet sites and performs operations corresponding to user commands, operations of the system comprising the steps of:
driving the service automation module according to user commands or automatic operation commands such that the commands are performed in Internet websites;
registering operations of the service automation module in an automatic operation command to check result information in the Internet sites performing the commands;
monitoring pattern variations of the Internet sites performing the commands according to the automatic operation commands; and
checking the result information if pattern variations of the Internet sites are detected, and displaying the result information.

7. A system for automatically providing Internet services without direct user connection to Internet sites by operation of a service automation module, which automatically connects to Internet sites and performs operations corresponding to user commands, operations of the system comprising the steps of:
determining if there is authorization to use the service automation module in the case where there is a user command or an automatic operation command to use Internet services;
updating the service automation module to a most recent service automation module through communications with a module management server if there is user authorization for the service automation module;
updating the set-up of the service automation module to a most recent set-up through communications with the module management server; and
operating the service automation module according to the commands using the updated service automation module and updated set-up to provide Internet services.

8. The system of claim 7 wherein the step of updating the service automation module to a most recent service automation module comprises the steps of:
making a request to verify whether the service automation module is a most recent service automation module;
determining if the service automation module is a most recent service automation module according to update information transmitted from the module management server;
discontinuing updating if the service automation module is a most recent service automation module, and making a request to download a most recent service automation module to the module management server if the service automation module is not a most recent service automation module;
updating the service automation module using a most recent service automation module transmitted from the module management server according to the download request; and
transmitting information of the updating of the service automation module to the module management server.

9. The system as in claim 7 or 8 wherein the step of updating the set-up of the service automation module to a most recent set-up comprises the steps of:
making a request to verify whether the set-up of the service automation module and of Internet service operations by the service automation module is a most recent set-up;
determining if the set-up is a most recent set-up according to update information transmitted from the module management server;
discontinuing updating if the set-up is identical to a set-up of when previously logged on, and making a request to download a most recent set-up to the module management server if the set-up is not a most recent set-up;
updating the service automation module using a most recent set-up transmitted from the module management server according to the download request; and
transmitting information of the updating of the service automation module to the module management server.

10. A system for automatically providing Internet services without direct user connection to Internet sites by operation of a service automation module, which automatically connects to Internet sites and performs operations corresponding to user commands, of a terminal, operations of the system comprising the steps of:
making a request to transmit information of the service automation module to the terminal if the user logs on through the terminal;
comparing the set-up information of the service automation module with stored update information to determine if the service automation module is a most recent service automation module; and
downloading a stored most recent service automation module to the terminal if the service automation module is not a most recent service automation module, and storing update information.

11. The system of claim 10 wherein the operations further comprise the steps of:
making a request to transmit to the terminal the set-up information of the service automation module and of Internet service operations by the service automation module if the user logs on through the terminal;
comparing the set-up information transmitted form the terminal with stored update information to determine if the set-up information is most recent set-up information; and
downloading stored most recent set-up information to the terminal if the set-up information is not most recent set-up information, and storing update information.
